(19) United States
(12) Patent Application Publication
(10) Pub. No.: US 2007/0041425 A1
(43) Pub. Date: Feb. 22, 2007

(54) Temperature detector, temperature detecting method, and semiconductor device having the temperature detector

(75) Inventors: Seung-won Lee, Seongnam-si (KR); Eui-seung Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD

(21) Appl. No.: 11/452,781

(22) Filed: Jun. 14, 2006

(30) Foreign Application Priority Data
Aug. 19, 2005 (KP) 10-2005-0076438

(51) Int. Cl. G01K 1/00

(52) U.S. Cl. 374/208

(57) ABSTRACT

A temperature detector, a temperature detecting method, and a semiconductor device having the temperature detector, in which the temperature detector includes a voltage generator, a selection circuit, and a comparator. The voltage generator generates first and second voltages that are inversely proportional to temperature. The selection circuit outputs the first voltage during a normal operation, and the second voltage during a self-test operation, wherein the second voltage is lower than the first voltage. The comparator compares a reference voltage with one of the first and second voltages output from the selection circuit, and generates a detection signal according to the comparison result. The temperature detecting method is performed by the temperature detector. The semiconductor device includes a reset signal generator that generates a reset signal for resetting a central processing unit (CPU) in response to a detection signal output from the temperature detector.

### CROSS-REFERENCE TO RELATED PATENT APPLICATION

This non-provisional application claims priority under 35 U.S.C. 119 to Korean Patent Application No. 10-2005-0076438, filed on Aug. 19, 2005, in the Korean Intellectual Property Office (KIPO), the contents of which are incorporated herein by reference.

### BACKGROUND OF THE INVENTION

1. Technical Field

The present disclosure relates to a semiconductor device having a temperature detector, and more particularly, to a temperature detector that can be tested, and a semiconductor device having the temperature detector.

2. Discussion of the Related Art

Typically, semiconductor device specifications prescribe the allowable ranges of voltages, temperatures, and frequencies in which the semiconductor device can operate correctly.

FIG. 1 is a circuit diagram of a semiconductor device having a conventional temperature detector. Referring to FIG. 1, the semiconductor device 10 includes a voltage detector 12, the temperature detector 14, a frequency detector 16, a reset signal generator 18, and a central processing unit (CPU) 20.

When a voltage that does not fall within the allowable range of voltages prescribed in the specifications, hereinafter referred to as “abnormal voltage,” is input, the voltage detector 12 detects the abnormal voltage and outputs a voltage detection signal VDET. When a temperature that does not fall within the allowable range of temperatures prescribed in the specifications, hereinafter referred to as “abnormal temperature,” is input, the temperature detector 14 detects the abnormal temperature and outputs a temperature detection signal TDET. When a frequency that does not fall within the allowable range of frequencies prescribed in the specifications, hereinafter referred to as “abnormal frequency,” is input, the frequency detector 16 detects the abnormal frequency and outputs a frequency detection signal FDET.

The reset signal generator 18 generates a reset signal RESET in response to at least one of the signals VDET, TDET, and FDET output from the voltage detector 12, the temperature detector 14, and the frequency detector 16. The CPU 20 is reset in response to the reset signal RESET. Thus, when an abnormal voltage, temperature, or frequency is input, the semiconductor device 10 halts the operation of the CPU 20 to protect the semiconductor device 10 from being damaged due to malfunctioning of the CPU 20 or from security difficulties.

A test device (not shown) tests whether the voltage detector 12, the temperature detector 14, and the frequency detector 16 operate correctly. That is, the test device applies an abnormal voltage to the voltage detector 12 to determine whether the voltage detector 12 operates correctly, and applies an abnormal frequency to the frequency detector 16 to determine whether the frequency detector 16 operates correctly. Since an abnormal temperature is difficult to apply to the temperature detector 14 using a general test device, it is difficult to test whether the temperature detector 14 operates correctly.

Also, when a test temperature to be applied to the temperature detector 14 using the test device, does not fall within the range of temperatures available to the temperature detector 14, as defined in the specifications, it is difficult to test whether the temperature detector 14 operates correctly with the test device.

For instance, when a test temperature that the test device can apply to the temperature detector 14 ranges from 0° C. to 85° C. and the temperatures available to the temperature detector 14 defined in the specifications range from −25° C. to 85° C., it is impossible to test whether the temperature detector 14 can detect a temperature between −25° C. and 0° C. by using the test device. Accordingly, it is impossible to test whether the temperature detector 14 can operate correctly at a temperature from −25° C. to 0° C.

### SUMMARY OF THE INVENTION

Embodiments of the present invention provide a temperature detector that can be tested, a temperature detecting method, and a semiconductor device having the temperature detector.

According to an embodiment of the present invention, there is provided a temperature detector that includes a voltage generator, a selection circuit, and a comparator. The voltage generator generates a first voltage and a second voltage that are inversely proportional to temperature. The selection circuit outputs the first voltage during a normal operation, and the second voltage during a self-test operation, wherein the second voltage is lower than the first voltage. The comparator compares a reference voltage with one of the first and second voltages output from the selection circuit, and generates a detection signal according to the comparison result.

The selection circuit outputs the first voltage when the test signal is at a first logic level, and outputs the second voltage when the test signal is at a second logic level. The first and second voltages are determined by a voltage of a diode.

According to an embodiment of the present invention, there is provided a method of detecting temperature, the method including generating a first voltage and a second voltage that are inversely proportional to temperature, wherein the second voltage is lower than the first voltage, outputting the first voltage in response to a first logic level of a test signal and outputting the second voltage in response to a second logic level of the test signal, and comparing a reference voltage with one of the first and second voltages and generating a temperature detection signal indicating the comparison result.

According to an embodiment of the present invention, there is provided a semiconductor device comprising a temperature detector that detects an applied temperature and generates a detection signal, a reset signal generator that generates a reset signal in response to the detection signal, and a central processing unit that is reset in response to the reset signal. The temperature detector comprises a voltage generator that generates a first voltage and a second voltage that are inversely proportional to temperature, a selection circuit that outputs one of the first and second voltages in response to a test signal, and a comparator that compares a reference voltage with one of the first and second voltages output from the selection circuit, and generates the detection signal indicating the comparison result.

### BRIEF DESCRIPTION OF THE DRAWINGS

Exemplary embodiments of the present invention can be understood in more detail from the following descriptions taken in conjunction with the attached drawings in which:

FIG. 1 is a circuit diagram of a semiconductor device having a conventional temperature detector;

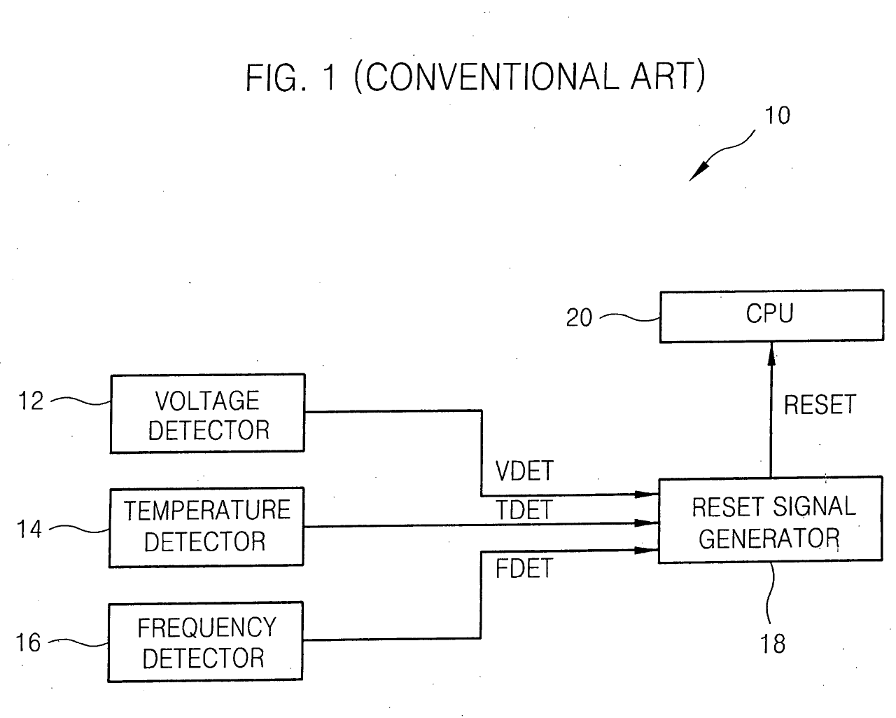

FIG. 2 is a circuit diagram of a temperature detector according to an embodiment of the present invention;

FIG. 3 is a graph illustrating an operational concept of a temperature detector according to an embodiment of the present invention;

FIG. 4 is a block diagram illustrating a semiconductor device having a temperature detector according to an embodiment of the present invention; and

FIG. 5 is a block diagram illustrating a method of testing a temperature detector according to an embodiment of the present invention.

### DETAILED DESCRIPTION OF EXEMPLARY EMBODIMENTS

Hereinafter, exemplary embodiments of the present invention will be described in detail with reference to the accompanying drawings. Like reference numerals denote like elements throughout the drawings.

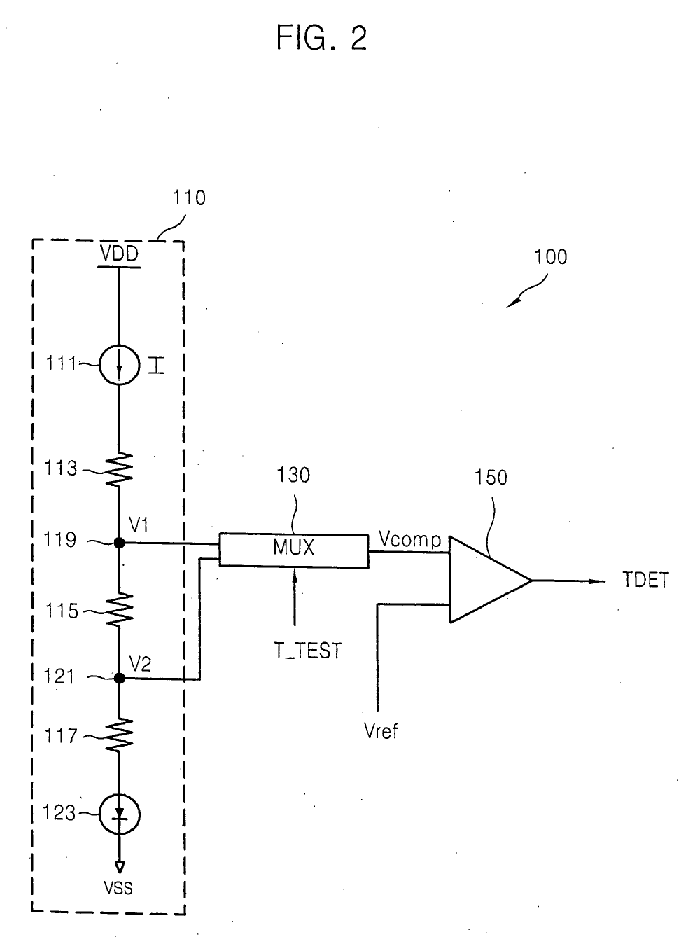

FIG. 2 is a circuit diagram of a temperature detector according to an embodiment of the present invention. Referring to FIG. 2, the temperature detector 100 includes a voltage generator 110, a selection circuit 130, and a comparator 150.

As illustrated in FIG. 2, the voltage generator 110 generates a first voltage V1 and a second voltage V2 that are inversely proportional to temperature. The voltage generator 110 includes a constant current source 111, a plurality of resistors 113, 115, and 117 that are connected in series, and a diode 123.

The first and second voltages V1 and V2 are determined by a voltage, e.g., built-in voltage, of the diode 123 and current I flowing through the resistors 113, 115, and 117. The first voltage V1 is higher than the second voltage V2. The first voltage V1 is used to detect an abnormal temperature applied to the temperature detector 100 when the temperature detector 100 operates in a normal mode, and the second voltage V2 is used to detect a test temperature when the temperature detector 100 operates in a self-test mode to determine whether the temperature detector is operating correctly.

The selection circuit 130 outputs a voltage Vcomp that is one of the first and second voltages V1 and V2 in response to an external test signal T_TEST. The selection circuit 130 may be embodied as a multiplexer (MUX).

For example, the selection circuit 130 outputs a voltage Vcomp that is the first voltage V1 in response to the test signal T_TEST that is at a first logic level, e.g., a low logic level (‘0’), when the temperature detector 100 operates in the normal mode, and outputs a voltage Vcomp that is the second voltage V2 in response to the test signal T_TEST that is at a second logic level, e.g., a high logic level (‘1’), when the temperature detector 100 operates in the self-test mode. When the temperature detector 100 operates in the normal mode, a terminal (not shown) receiving the test signal T_TEST is preferably kept open.

The comparator 150 receives and compares a reference voltage Vref and the voltage Vcomp output from the selection circuit 130, and generates a detection signal TDET according to the comparison result.

For example, when the voltage Vcomp output from the selection circuit 130 is greater than the reference voltage Vref, the comparator 150 generates the detection signal TDET that is at a first logic level. As illustrated in FIG. 2, when an increase in a temperature applied to the temperature detector 100 causes the voltage Vcomp output from the selection circuit 130 to be equal to or less than the reference voltage Vref, the comparator 150 generates the detection signal TDET that is at a second logic level. Thus, when an abnormal temperature is applied to the temperature detector 100, the comparator 150 preferably generates the detection signal TDET that is at the second logic level.

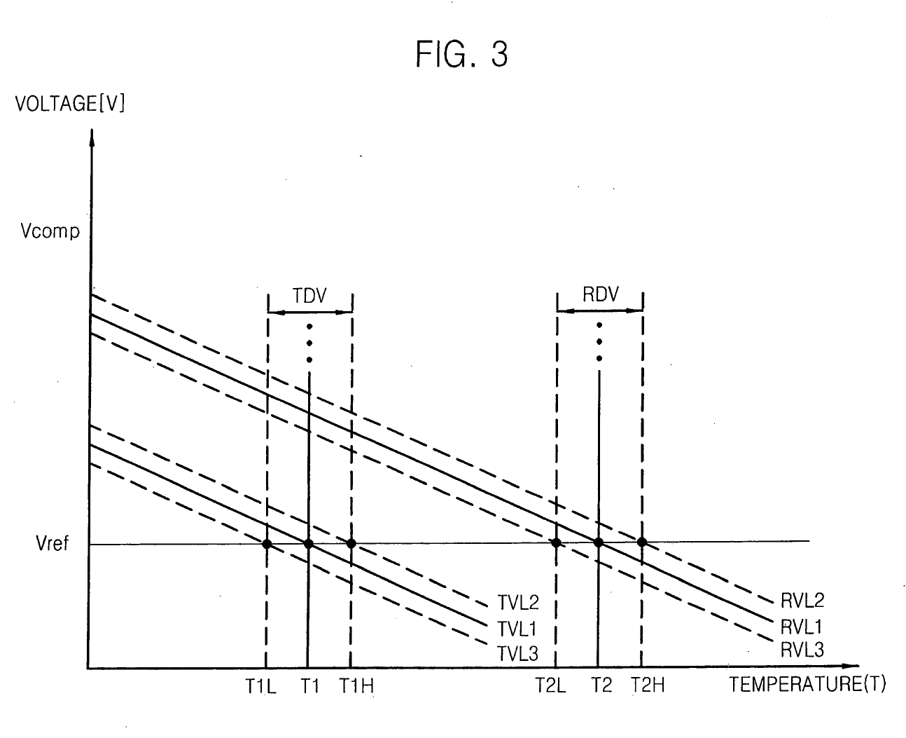

FIG. 3 is a graph illustrating an operational concept of a temperature detector according to an embodiment of the present invention. The operational concept of the temperature detector according to an embodiment of the present invention will now be described with reference to FIGS. 2 and 3.

Assuming that a voltage Vcomp output from the selection circuit 130 of each of a plurality of temperature detectors is the first voltage V1, in which each of the temperature sensors is like the temperature detector 100 shown in FIG. 2, and which are included in a semiconductor device (not shown), moves through corresponding voltage lines RVL1, RVL2, and RVL3 according to a variation of an external voltage VDD, the resistance values of the resistors 113, 115, and 117, a voltage of the diode 123, and/or a supplied current I, abnormal temperatures to be detected by the respective temperature detectors are different from one another.

For example, a comparator of a first temperature detector compares a reference voltage Vref with a voltage on the voltage line RVL1 when a temperature of T2 or more is applied, and generates a detection signal TDET that is at the second logic level; a comparator of a second temperature detector compares the reference voltage Vref with a voltage on the voltage line RVL3 when a temperature of T2L or more is applied, and generates a detection signal TDET that is at the second logic level; and a comparator of a third temperature detector compares the reference voltage Vref with a voltage on the voltage line RVL2 when a temperature of T2H or more is applied, and generates a detection signal TDET that is at the second logic level. In this case, in order to test whether the first through third temperature detectors operate correctly using a test device, the test device must respectively apply temperatures of T2 or more, T2L or more, and T2H or more to them, and detect temperatures to be detected as abnormal temperatures by the respective first through third temperature detectors.

Here, T2, T2L, and T2H are referred to as abnormal temperature detection points. However, the abnormal temperature detection points vary according to variations of the external voltages VDD, the resistance values of the resistors 113, 115, and 117, the voltage output from the diode 123, and/or the supplied current I.

However, in the present embodiment, whether the temperature detector 100 operates correctly is determined by testing it at a normal temperature using the second voltage V2 lower than the first voltage V1, and the reference voltage Vref. For this reason, the test device need not apply actual abnormal temperatures to the temperature detector 100. Here, the normal temperature (or a normal temperature region) indicates a temperature to be supplied by the test device.

The first voltage V1 changing along the voltage line RVL1 is mapped to the second voltage V2 changing along a voltage line TVL1, the first voltage V1 changing along the voltage line RVL2 is mapped to the second voltage V2 changing along a voltage line TVL2, and the first voltage changing along the voltage line RVL3 is mapped to the second voltage V2 changing along a voltage line TVL3.

If the first voltage V1, which is expected to change along the voltage line RVL1 according to a change of the temperature, changes along the voltage line RVL2 when the temperature detector 100 operates in a normal mode, due to process changes, including changes in the external voltage VDD, the resistance values of the resistors 113, 115, and 117, the voltage of the diode 123, and/or the supplied current I, the abnormal temperature detection point that the temperature detector 100 can detect is changed from T2 to T2H. Since the change in the first voltage V1 is mapped to the change in the second voltage V2, the abnormal temperature detection point that the temperature detector 100 can detect is changed from T1 to T1H during operation in the self-test mode of the temperature detector 100.

Thus, when the first temperature detector 100 detects T2 as an abnormal temperature detection point during operation in the normal mode, it detects T1 as an abnormal temperature detection point during operation in the self-test mode. If an abnormal temperature detection point that the second temperature detector 100 can detect changes from T2 to T2H due to process changes, the second temperature detector 100 detects T1H as an abnormal temperature detection point during operation in the self-test mode.

Based on the above principle, it is possible to determine an abnormal temperature detection point that the temperature detector 100 can detect during operation in the normal mode using a change in the abnormal temperature detection point detected by the temperature detector 100 during operation in the self-test mode.

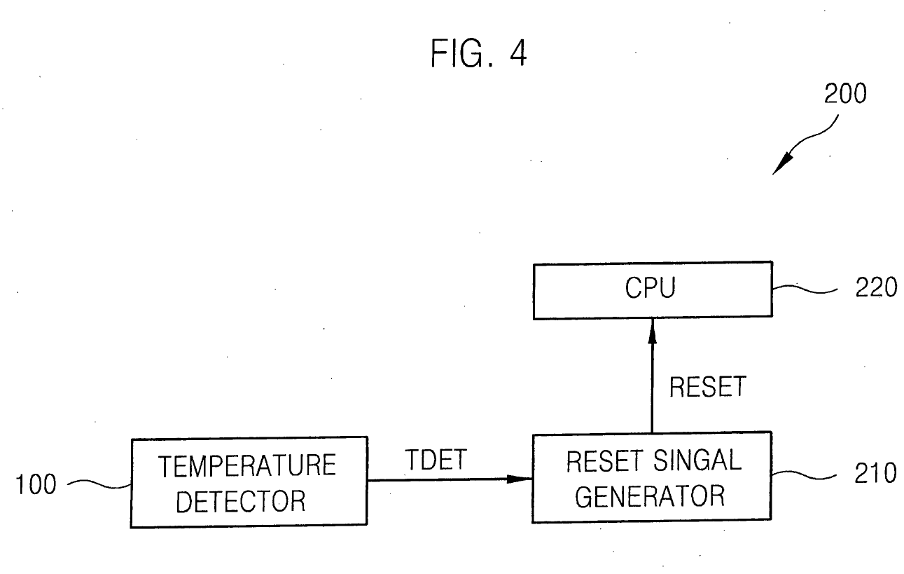

FIG. 4 is a block diagram of a semiconductor device 200 having a temperature detector 100 according to an embodiment of the present invention. Referring to FIG. 4, the semiconductor device 200 includes the temperature detector 100, a reset signal generator 210, and a central processing unit (CPU) 220. The semiconductor device 200 may be embodied as a smart card.

The temperature detector 100 detects an abnormal temperature and generates a detection signal TDET that is at the second logic level. The reset signal generator 210 generates a reset signal RESET having the second logic level in response to the detection signal TDET having the second logic level. The CPU 220 is reset in response to the reset signal RESET having the second logic level. Accordingly, it is possible to protect the semiconductor device 200 from being damaged due to malfunctioning or from security difficulties when an abnormal temperature is applied thereto.

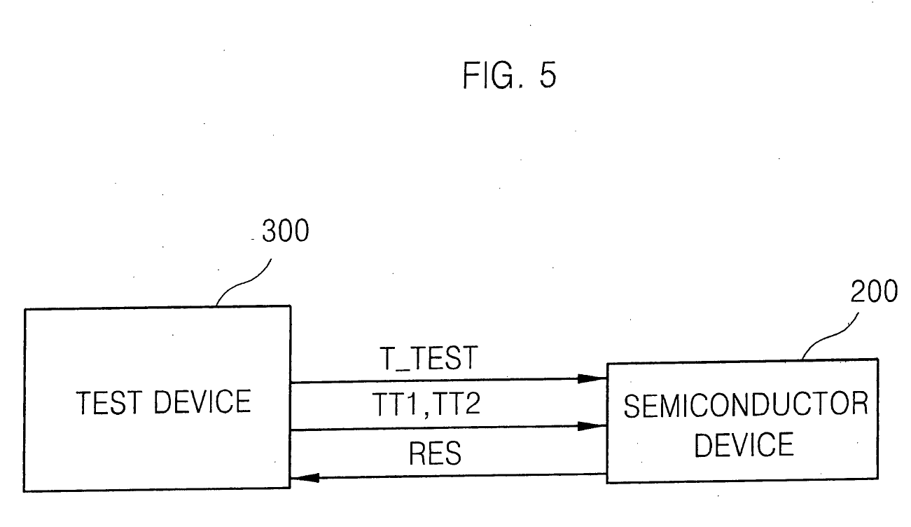

FIG. 5 is a block diagram illustrating a method of testing a temperature detector according to an embodiment of the present invention. A method of testing the temperature detector 100, or the semiconductor device 200 having the temperature detector, at a normal temperature will now be described with reference to FIGS. 2 through 5.

First, for convenience of explanation, it is assumed that the temperature detector 100 residing in the semiconductor device 200 generates a detection signal TDET having the second logic level at a first test temperature TT1, e.g., T1 of FIG. 3, during operation in the self-test mode, and generates a detection signal TDET having the second logic level at a first actual temperature T2 during operation in the normal mode.

When a test begins, a test device 300 applies a test signal T_TEST having the second logic level to the temperature detector 100 built in the semiconductor device 200. Then, the selection circuit 130 of the temperature detector 100 outputs a second voltage V2 as a comparison voltage Vcomp in response to the test signal T_TEST having the second logic level.

Next, the test device 300 applies a first test temperature TT1, e.g., T1 of FIG. 3, to the semiconductor device 200. In this case, when the semiconductor device 200 generates a predetermined signal, such as the detection signal T_TEST having the second logic level, in response to the first test temperature TT1, it is determined that the semiconductor device 200 correctly detects T2 as an abnormal temperature.

However, when the semiconductor device 200 generates a predetermined signal, such as a detection signal TDET having the first logic level, at the first test temperature T1, the test device 300 applies a second test temperature TT2, e.g., T1H shown in FIG. 3, to the semiconductor device 200, the second test temperature TT2 being higher than the first test temperature TT1.

If the semiconductor device 200 generates a predetermined signal, such as the detection signal TDET having the second logic level in response to the. second test temperature T1H, an abnormal temperature detection point in the semiconductor device 200 is changed from T2 to T2H.

Also, if the semiconductor device 200 generates no signal in response to at least one of the first test temperature TT1 and the second test temperature TT2, the temperature detector 100 of the semiconductor device 200 is considered defective.

In FIG. 3, RDV and TDV denote the range of a variation in an actual detection temperature and the range of a variation in a test temperature due to process changes, respectively.

Also, when the abnormal temperature detection point changes from T1L to T1 during operation in the self-test mode, the abnormal temperature detection point that the temperature detector 100 can actually detect is changed from T2L to T2. If the abnormal temperature detection point changes from T1 to T1L during operation in the self-test mode, the abnormal temperature detection point that the temperature detector 100 can actually detect changes from T2 to T2L.

Accordingly, when the corresponding abnormal temperature detection point of the temperature detector 100 changes due to process changes, it is possible to determine whether the temperature detector 100 correctly detects abnormal temperatures at a normal temperature. Accordingly, the present invention is applicable to the manufacture or development of a semiconductor device having a temperature detector.

As described above, according to a temperature detector, a temperature detecting method, and a semiconductor device having the temperature detector according to the present invention, it is possible to easily perform a virtual test to determine whether the temperature detector operates correctly.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A temperature detector comprising:
a voltage generator generating a first voltage and a second voltage which are inversely proportional to temperature;
a selection circuit outputting one of the first and second voltages in response to a test signal; and
a comparator comparing a reference voltage with one of the first and second voltages output from the selection circuit, and generating a detection signal according to a comparison result.

2. The temperature detector of claim 1, further comprising a test terminal receiving the test signal,
wherein the selection circuit outputs the first voltage when the test signal is at a first logic level, and outputs the second voltage when the test signal is at a second logic level.

3. The temperature detector of claim 1, wherein the voltage generator comprises:
a constant current source;
a diode; and
a plurality of resistors connected in series between the constant current source and the diode,
wherein each of the first and second voltages corresponds to voltages of corresponding resistors of the plurality of resistors.

4. The temperature detector of claim 1, wherein the second voltage is lower than the first voltage.

5. A semiconductor device comprising:
a temperature detector detecting an applied temperature and generating a detection signal;
a reset signal generator generating a reset signal in response to the detection signal; and
a central processing unit that is reset in response to the reset signal,
wherein the temperature detector comprises:
a voltage generator generating a first voltage and a second voltage which are inversely proportional to temperature;
a selection circuit outputting one of the first and second voltages in response to a test signal; and
a comparator comparing a reference voltage with one of the first and second voltages output from the selection circuit, and generating the detection signal according to the comparison result.

6. The semiconductor device of claim 5, wherein the temperature detector further comprises a test terminal receiving the test signal,
wherein the selection circuit outputs the first voltage when the test signal is at a first logic level, and outputs the second voltage when the test signal is at a second logic level.

7. The semiconductor device of claim 5, wherein the voltage generator comprises:
a diode; and
a plurality of resistors connected to the diode in series,
wherein the first and second voltages are generated based on a voltage output from the diode.

8. A method of detecting temperature, comprising:
generating a first voltage and a second voltage which are inversely proportional to temperature;
outputting the first voltage in response to a first logic level of a test signal, and the second voltage in response to a second logic level of the test signal, wherein the second voltage is lower than the first voltage; and
comparing a reference voltage with one of the first and second voltages, and generating a signal corresponding to a comparison result as a temperature detection signal.

9. The method of claim 8, wherein the first and second voltages are generated based on a voltage of a diode.
